(19) United States
(12) Patent Application Publication
(10) Pub. No.: US 2023/0053866 A1
(43) Pub. Date: Feb. 23, 2023

(54) COMPUTER SYSTEM, AND DATA RETRIEVAL SUPPORT METHOD

(71) Applicant: Hitachi, Ltd., Tokyo (JP)

(72) Inventors: Katsuaki NAKAMIZO, Tokyo (JP); Yuji KOSEKI, Tokyo (JP); Yasuhiro KAWABATA, Tokyo (JP); Atsushi HIRATA, Tokyo (JP)

(21) Appl. No.: 17/690,247

(22) Filed: Mar. 9, 2022

(30) Foreign Application Priority Data
Aug. 23, 2021 (JP) 2021-135718

(51) Int. Cl. G06F 16/242; G06F 16/2457; G06F 16/25

(52) U.S. Cl. CPC G06F 16/2423; G06F 16/2445; G06F 16/24578; G06F 16/25

(57) ABSTRACT

A computer system, which is coupled to a plurality of databases configured to store data having different data types, being configured to: manage a catalog database configured to store a catalog including information on an SQL which has been used; execute, in a case of receiving a retrieval request including a first SQL from a user terminal, the first SQL and output an execution result of the first SQL to the user terminal; refer to the catalog database, and select at least one recommended SQL in which a retrieval condition, which is a retrieval condition for retrieving data by joining the plurality of databases, and is similar to the retrieval condition of the first SQL, is defined; and present the at least one recommended SQL to the user terminal.

### CLAIM OF PRIORITY

The present application claims priority from Japanese patent application JP 2021-135718 filed on Aug. 23, 2021, the content of which is hereby incorporated by reference into this application.

### BACKGROUND OF THE INVENTION

This invention relates to a data retrieval technology using a plurality of databases.

In big data analysis, analysis combining a plurality of types of data is performed in order to obtain new knowledge. A user obtains the data for analysis from a database by using an SQL.

As a technology for supporting data retrieval from a database, for example, the technology as described in JP 2003-228586 A is known. In JP 2003-228586 A, there is described “a database access apparatus for accessing a database 102 by using a Web server 101. The database access apparatus includes a database access module 106 configured to read an SQL input by a user from an operation screen of a browser and to access the database based on the read SQL, an SQL history accumulation module 107 configured to accumulate SQLs which have been executed by the database access module in a history file, and an SQL retrieval procedure creation module 108 configured to create a procedure for retrieving an SQL which approximates the SQL input by the user from the SQLs accumulated in the history file and to transmit the created procedure to a client. The database access apparatus supports SQL creation by the client.”

In order to perform retrieval by using a combination of a plurality of types of data, it is required to be familiar with data structure and data items. In recent years, big data analysis using publicly available data has also been performed. In a case where publicly available data is to be obtained, it is required to clearly present a purpose of use, for example, and specify data tables and data item names to be obtained. In other words, it is required to accurately specify the data items under a situation in which verification in advance is not possible. Therefore, in data analysis until now, there has been a problem in that the analysis relies on experience and intuition of a data analyst.

### SUMMARY OF THE INVENTION

The technology as described in JP 2003-228586 A is a technology for presenting past SQLs and supporting creation of an intended SQL. However, this technology is based on the premise that a single database is to be searched, and it is difficult to apply this technology to big data analysis dealing with a plurality of databases.

This invention is to achieve a technology for presenting an SQL for obtaining data from which there is a possibility of obtaining new knowledge in data retrieval combining a plurality of databases.

A representative example of the present invention disclosed in this specification is as follows: a computer system, which is coupled to a plurality of databases configured to store data having different data types, comprises a computer including a processor, a storage device coupled to the processor, and a network interface coupled to the processor. The computer system is configured to: manage a catalog database configured to store a catalog including information on an SQL which has been used; execute, in a case of receiving a retrieval request including a first SQL from a user terminal, the first SQL and output an execution result of the first SQL to the user terminal; refer to the catalog database, and select at least one recommended SQL in which a retrieval condition, which is a retrieval condition for retrieving data by joining the plurality of databases, and is similar to the retrieval condition of the first SQL, is defined; and present the at least one recommended SQL to the user terminal.

According to the at least one embodiment of this invention, it is possible to present the SQL for obtaining data from which there is a possibility of obtaining new knowledge in the data retrieval combining the plurality of databases. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a system according to a first embodiment of this invention;

FIG. 2 is a diagram for illustrating an example of a hardware configuration of a computer included in a retrieval system in the first embodiment;

FIG. 3A and FIG. 3B are tables for showing an example of data structure of the data stored in a user DB in the first embodiment;

FIG. 4 is a diagram for illustrating an example of data structure of a catalog stored in a catalog DB in the first embodiment;

FIG. 5 is a flowchart for illustrating an example of processing to be executed by the retrieval system of the first embodiment;

FIG. 6 is a diagram for illustrating an example of the SQL which is received or output by the retrieval system 100 in the first embodiment;

FIG. 7 is a diagram for illustrating a configuration example of a system according to the second embodiment;

FIG. 8A, FIG. 8B, and FIG. 8C are tables for showing an example of data structure of the data stored in a trend DB in a second embodiment;

FIG. 9 is a flowchart for illustrating an example of processing to be executed by the retrieval system in the second embodiment; and

FIG. 10 is a diagram for illustrating an example of an SQL generated by catalog automatic generation processing in a third embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

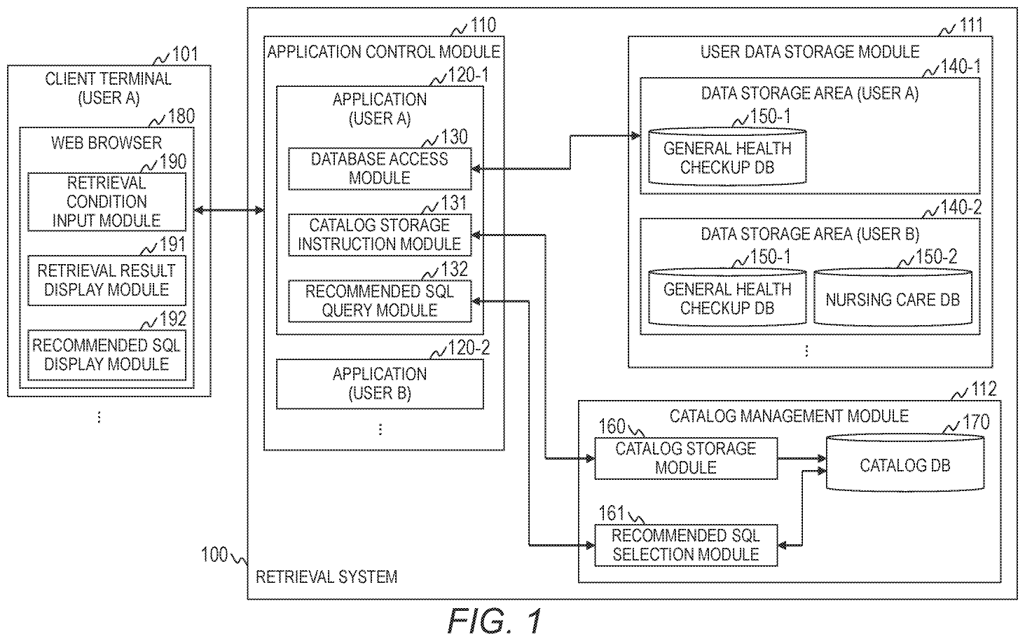

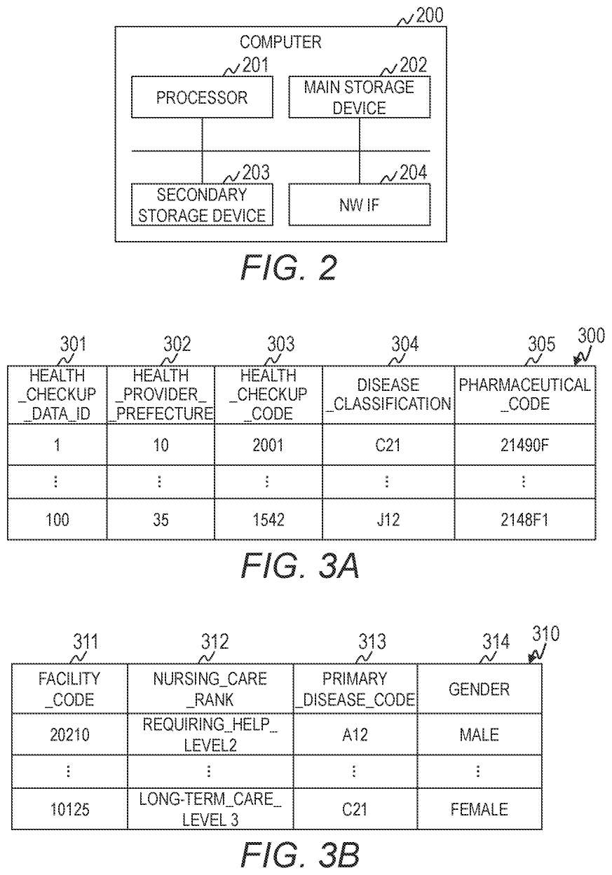

FIG. 1 is a diagram for illustrating a configuration example of a system according to a first embodiment of this invention. FIG. 2 is a diagram for illustrating an example of a hardware configuration of a computer included in a retrieval system in the first embodiment.

The system includes a retrieval system 100 and a client terminal 101. The retrieval system 100 and the client terminal 101 are coupled to each other via a network (not shown). The network is, for example, a wide area network (WAN) or a local area network (LAN), and the coupling method may be wired or wireless.

The client terminal 101 is a terminal to be used by the user. The client terminal 101 includes a processor, a main storage device, a network interface, an input apparatus, and an output apparatus (those parts are not shown).

The client terminal 101 accesses the retrieval system 100 to retrieve data via a web browser 180. The Web browser 180 includes a retrieval condition input module 190, a retrieval result display module 191, and a recommended SQL display module 192.

The retrieval condition input module 190 receives input of an SQL in which a retrieval condition for retrieving data is defined. The retrieval condition input module 190 transmits a retrieval request including the SQL to the retrieval system 100. The retrieval result display module 191 receives retrieval results for the retrieval request from the retrieval system 100, and presents the retrieval results to the user. The user analyzes the data by using the data obtained as the retrieval results. The recommended SQL display module 192 presents a recommended SQL selected by the retrieval system 100 to the user.

As used herein, “SQL” means an SQL statement (command) described by using the SQL language, and “retrieval condition” means, for example, a combination of data items obtained from a user DB 150 and a join condition (JOIN) between and the user DBs 150.

The retrieval system 100 is a system for performing data retrieval from the user DB 150, and is built from a computer 200 like that illustrated in FIG. 2. The retrieval system 100 may include a storage system, a network switch, and the like.

The computer 200 includes a processor 201, a main storage device 202, a secondary storage device 203, and a network interface 204. The computer 200 may also include an input apparatus and an output apparatus.

The processor 201 executes programs stored in the main storage device 202. The processor 201 operates as a function unit (module) which implements a specific function by executing processing in accordance with the programs. In the following description, when processing is described with the function unit as the subject of the sentence, this indicates that the processor 201 executes a program for implementing the function unit. The main storage device 202 is a memory, for example, and stores the programs executed by the processor 201 and the data used by the programs. The secondary storage device 203 is, for example, a hard disk drive (HDD) or a solid state drive (SSD), and stores data permanently. The programs and data stored in the main storage device 202 may be stored in the secondary storage device 203. In this case, the processor 201 reads out programs and data from the secondary storage device 203, and loads the read programs and data onto the main storage device 202. The network interface 204 communicates to and from other apparatus via the network.

The retrieval system 100 includes an application control module 110, a user data storage module 111, and a catalog management module 112.

The user data storage module 111 includes a data storage area 140 for each user. The data storage area 140 stores the user DB 150 which stores data registered by the user or obtained from the outside.

The user DB 150 stores, for example, publicly available data that is obtained by the user by applying to a public institution. In FIG. 1, there are illustrated a general health checkup DB 150-1 and a nursing care DB 150-2 as examples of the user DB 150. In this invention, the type and data structure of the data stored in the user DB are not limited.

The application control module 110 controls an application 120 for retrieving data.

The application 120 includes a database access module 130, a catalog storage instruction module 131, and a recommended SQL query module 132.

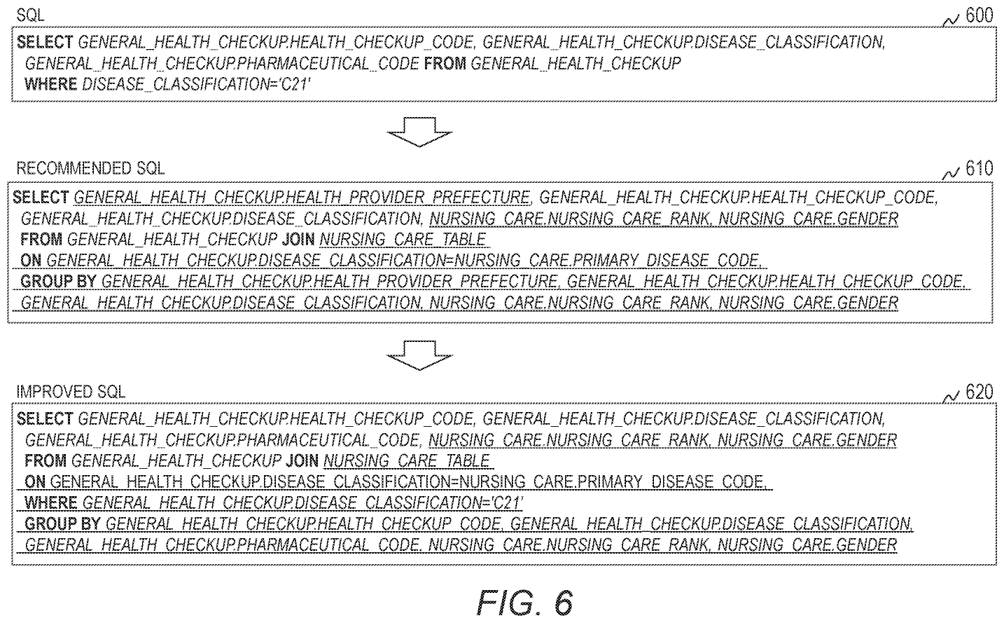

The database access module 130 accesses the user DB 150 and retrieves data based on the SQL included in the retrieval request. The catalog storage instruction module 131 instructs the catalog management module 112 to save information on the SQL included in the retrieval request as a catalog 400 which is illustrated in FIG. 4. The recommended SQL query module 132 queries the recommended SQL.

The application 120 may have a function of performing data analysis using the retrieved data.

The catalog management module 112 manages the catalog 400, and selects the recommended SQL from the catalog 400. The catalog management module 112 includes a catalog storage module 160 and a recommended SQL selection module 161, and also stores a catalog DB 170.

The catalog DB 170 is a database for storing the catalog 400.

The catalog storage module 160 generates the catalog 400 in accordance with an instruction from the catalog storage instruction module 131, and stores the catalog 400 in the catalog DB 170. The recommended SQL selection module 161 selects the recommended SQL from among the SQLs included in the catalog 400 stored in the catalog DB 170.

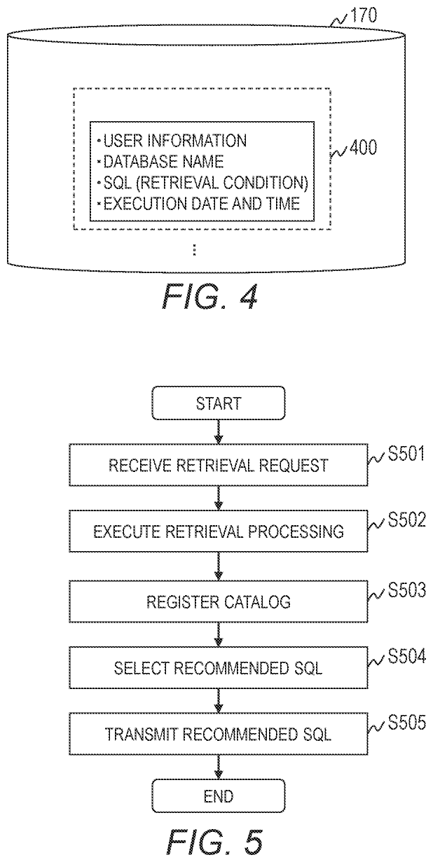

FIG. 3A and FIG. 3B are tables for showing an example of data structure of the data stored in the user DB 150 in the first embodiment.

In FIG. 3A, there is shown data structure of the data stored in the general health checkup DB 150-1. The general health checkup DB 150-1 stores a table 300. The table 300 stores entries each including a health checkup data ID 301, a health provider prefecture 302, a health checkup code 303, a disease classification 304, and a pharmaceutical code 305. One entry corresponds to one piece of health checkup data. The data items (fields) included in the health checkup data are not limited to those described above, and may not include one of the data items described above, or may include other data items.

In FIG. 3B, there is shown data structure of the data stored in the nursing care DB 150-2. The nursing care DB 150-2 stores a table 310. The table 310 stores entries each including a facility code 311, a nursing care rank 312, a primary disease code 313, and a gender 314. One entry corresponds to one piece of nursing care certification data of one person. The data items (fields) included in the nursing care certification data are not limited to those described above, and may not include one of the data items described above, or may include other data items.

FIG. 4 is a diagram for illustrating an example of data structure of a catalog stored in the catalog DB 170 in the first embodiment.

The catalog DB 170 stores a plurality of catalogs 400. Identification information is assigned to each catalog 400. The catalog 400 includes the SQL, user information on the user who has performed the retrieval through use of the SQL, a name of the user DB 150 to be searched, and an execution date and time of retrieval. The catalog 400 may also include other information.

In the first embodiment, the SQL used by the user is managed as the catalog 400. As a result, the search knowledge held by the user can be shared by all the users using the retrieval system 100.

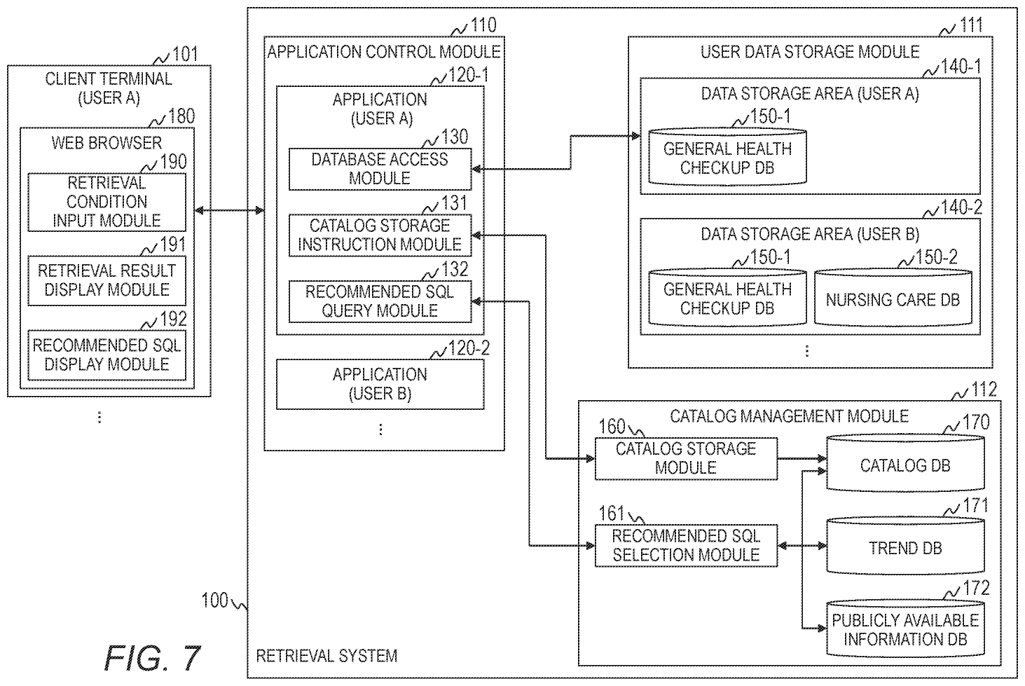

FIG. 5 is a flowchart for illustrating an example of processing to be executed by the retrieval system 100 of the first embodiment.

The user operates the web browser 180 of the client terminal 101 to input the retrieval condition and instruct that retrieval is to be executed. In this case, the retrieval condition input module 190 of the client terminal 101 transmits a retrieval request including the retrieval condition to the application 120 corresponding to the user.

In a case where the application 120 of the retrieval system 100 receives a retrieval request (Step S501), the application 120 executes retrieval processing (Step S502).

Specifically, the database access module 130 accesses the user DB 150 stored in the data storage area 140 corresponding to the user by using the SQL included in the retrieval request, and retrieves the data. The database access module 130 transmits the retrieval results to the client terminal 101. The retrieval result display module 191 of the client terminal 101 displays the retrieval results.

Next, the application 120 of the retrieval system 100 registers the catalog 400 in the catalog management module 112 (Step S503).

Specifically, the catalog storage instruction module 131 outputs a registration request to the catalog management module 112 together with information on the retrieval request. The catalog storage module 160 of the catalog management module 112 generates a catalog 400 based on the information, assigns identification information to the catalog 400, and stores the catalog 400 having the identification information in the catalog DB 170.

In the first embodiment, a catalog 400 is generated and accumulated in the catalog DB 170 each time the retrieval processing is executed.

Next, the application 120 of the retrieval system 100 selects the recommended SQL by transmitting an instruction to output the recommended SQL to the catalog management module 112 (Step S504). The output instruction includes the SQL which has been used.

Specifically, in a case where the recommended SQL selection module 161 receives an output instruction from the recommended SQL query module 132, the recommended SQL selection module 161 identifies an SQL in which the retrieval condition for retrieving the data by joining the plurality of user DBs 150 is defined. The recommended SQL selection module 161 calculates a similarity degree of the retrieval condition of the SQL included in the output instruction and the identified SQL. The recommended SQL selection module 161 selects the recommended SQL based on the similarity degree, and transmits the selected recommended SQL to the recommended SQL query module 132. For example, the SQL having the highest similarity degree may be selected as the recommended SQL, a predetermined number of SQLs may be selected as the recommended SQLs in descending order of similarity degree, or an SQL having a similarity degree larger than a threshold value may be selected as the recommended SQL.

The similarity degree of the retrieval condition is calculated based on a degree of matching between combinations of data items (matching |number|[A1] of data items) and a degree of matching between join conditions (syntax). A calculation algorithm is set in which the similarity degree of the retrieval condition, which includes the data items of the SQL included in the output instruction and has a high degree of matching with the join condition of that SQL, is high.

In a case where the retrieval condition is similar, it is presumed that the retrieval purpose is also similar. The retrieval system 100 presents the SQL in which a similar retrieval condition is defined as the recommended SQL from which useful knowledge may be obtained.

Next, the application 120 of the retrieval system 100 transmits the recommended SQL to the client terminal 101 (Step S505). The application 120 of the retrieval system 100 then ends the processing.

The recommended SQL display module 192 of the client terminal 101 displays the received recommended SQL to the user.

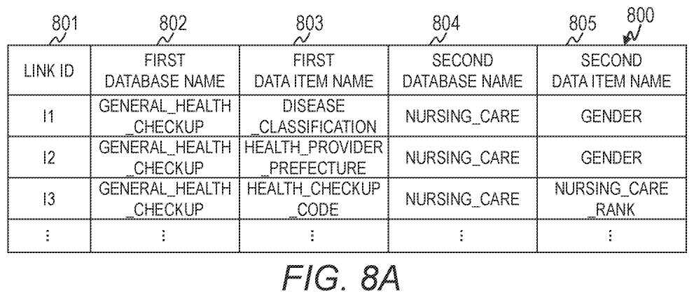

There is now described a specific example of the display of the recommended SQL. FIG. 6 is a diagram for illustrating an example of the SQL which is received or output by the retrieval system 100 in the first embodiment.

An SQL 600 represents the SQL input by the user. A recommended SQL 610 represents the recommended SQL selected by the retrieval system 100.

The recommended SQL 610 defines a retrieval condition different from that of the SQL 600. As used herein, a different retrieval condition means that at least one of the combinations of the items or the join conditions is different. Meanwhile, the retrieval condition defined in the recommended SQL 610 is similar to the retrieval condition defined in the SQL 600. In other words, the retrieval condition defined in the recommended SQL 610 includes the data items targeted by the SQL 600, and having a high degree of matching with the join condition of the SQL 600.

The SQL 600 searches the general health checkup DB 150-1, whereas the recommended SQL 610 searches the general health checkup DB 150-1 and the nursing care DB 150-2. Further, it can be seen that the recommended SQL 610 uses a join condition which joins the disease classification 304 of the general health checkup DB 150-1 and a primary disease code 313 of the nursing care DB 150-2.

In this way, the retrieval system 100 presents an SQL which performs data retrieval combining a user DB 150 having some kind of relationship with the user DB 150 to be searched. As a result, the user can confirm the combination of the data items and the join condition of relevant user DBs 150. In other words, it is possible to perform a search that incorporates the search knowledge of other users. Further, the user can grasp the combination of useful data items by referring to the new user DB 150. For example, the nursing care rank and gender, for example, of the nursing care DB 150-2 can be grasped as a combination of useful data items.

The user may use the recommended SQL 610 as it is, or the recommended SQL 610 may be rearranged. An SQL 620 represents an SQL newly input by the user who has referred to the recommended SQL 610.

In the SQL 620, a nursing care rank 312 and a gender 314 are added to the combination of the data items of the recommended SQL 610, and changes have been added from the join condition of the recommended SQL 610.

According to the first embodiment, an SQL for obtaining data from which there is a possibility of obtaining new knowledge can be presented. As a result, even when there is no detailed knowledge about the user DB 150, data retrieval combining a plurality of user DBs 150 is possible.

### Second Embodiment

In a retrieval system 100 in a second embodiment of this invention, in a case where a plurality of recommended SQLs have been selected, the plurality of recommended SQLs are ranked, and the ranked recommended SQLs are presented to the user. Description is now given of the second embodiment while mainly focusing on the differences from the first embodiment.

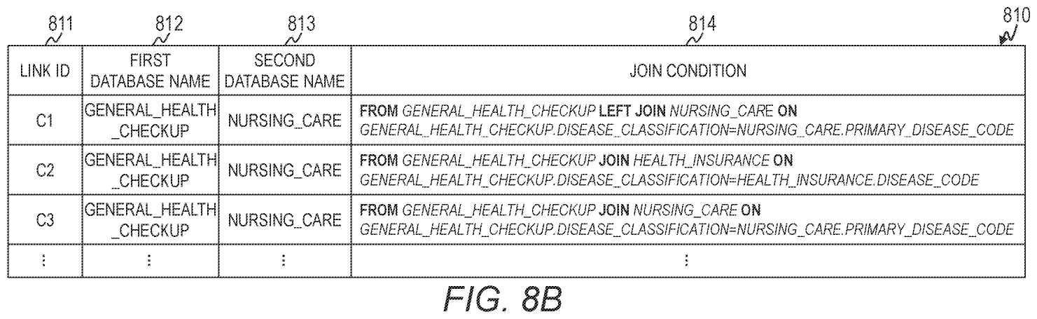

FIG. 7 is a diagram for illustrating a configuration example of a system according to the second embodiment.

In the second embodiment, a part of the configuration of the catalog management module 112 is different. Specifically, the catalog management module 112 holds a trend DB 171 and a publicly available information DB 172.

The trend DB 171 is a database for storing data indicating a usage trend of a retrieval condition. The publicly available information DB 172 is a database for storing information that is publicly available, for example, academic papers and pamphlets. The retrieval system 100 collects information by periodically crawling external Web pages and external document databases, for example, and registers the collected information in the publicly available information DB 172.

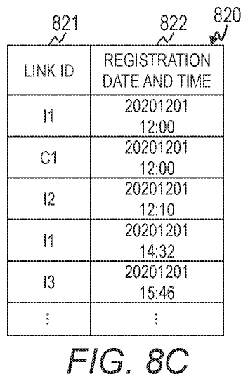

FIG. 8A, FIG. 8B, and FIG. 8C are tables for showing an example of data structure of the data stored in the trend DB 171 in the second embodiment.

The trend DB 171 stores a first link table 800, a second link table 810, and a history table 820.

The first link table 800 is a table for managing combinations of data items obtained from a plurality of user DBs 150, and stores entries each including a link ID 801, a first database name 802, a first data item name 803, a second database name 804, and a second data item name 805. There is one entry for one combination of data items.

The link ID 801 is a field for storing identification information on a combination of data items. The first database name 802 and the second database name 804 are fields for storing the name of the user DB 150. The first data item name 803 and the second data item name 805 are fields for storing the name of the data item included in the data stored in the user DB 150.

The second link table 810 is a table for managing a join condition between user DBs 150, and stores entries each including a link ID 811, a first database name 812, a second database name 813, and a join condition 814. There is one entry for one join condition between the user DBs 150.

The link ID 811 is a field for storing identification information on a join condition between user DBs 150. The first database name 812 and the second database name 813 are fields for storing the name of the user DB 150. The join condition 814 is a field for storing the join condition between user DBs 150 which is included in the SQL.

It is acceptable that the trend DB 171 include only any one of the first link table 800 and the second link table 810.

The history table 820 is a table for managing a usage history of the combinations of data items and the join conditions, and stores entries each including a link ID 821 and a registration date and time 822. There is one entry for each use.

The link ID 821 is a field for storing identification information on any one of the link ID 801 and the link ID 811. The registration date and time 822 is a field for storing the date and time when the SQL including the combination of data items or the join condition corresponding to the link ID 821 is executed.

The data structure of the user DB 150 and the data structure of the catalog DB 170 managed by the retrieval system 100 in the second embodiment are identical to those in the first embodiment.

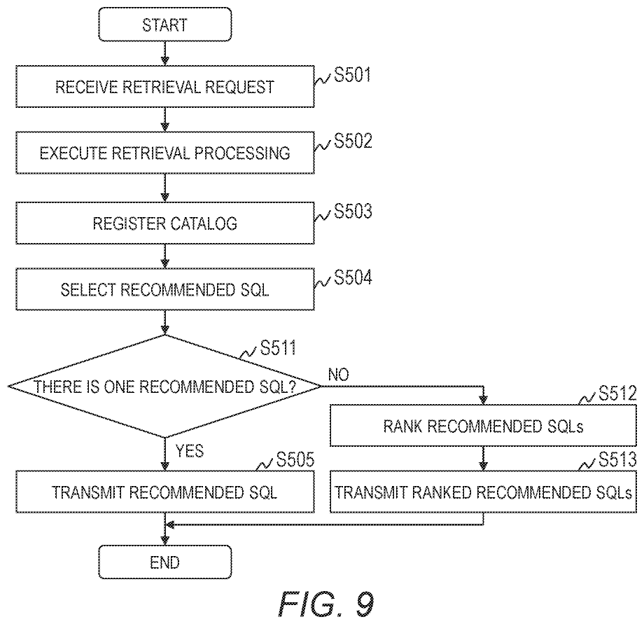

In the second embodiment, a part of the processing executed by the retrieval system 100 is different. FIG. 9 is a flowchart for illustrating an example of processing to be executed by the retrieval system 100 in the second embodiment.

The processing step of each of Step S501 and Step S502 is identical to that in the first embodiment.

In Step S503, the catalog 400 is registered and the trend DB 171 is updated. Specifically, the following processing is executed.

(Step S503-1) The catalog storage module 160 obtains an SQL from the catalog 400 included in the registration request and identifies the combination of data items and the join condition by analyzing the obtained SQL.

(Step S503-2) The catalog storage module 160 refers to the first link table 800 and determines whether or not there is an entry matching the combination of data items.

(Step S503-3) In a case where there is an entry matching the combination of data items, the catalog storage module 160 obtains identification information from the link ID 801 of the entry. The catalog storage module 160 adds an entry to the history table 820, sets the obtained identification information in the link ID 821, and stores the SQL execution date and time in the registration date and time 822. In a case where there are no entries matching the combination of data items, the catalog storage module 160 registers an entry in the first link table 800, and sets the identification information in the link ID 801. Further, the catalog storage module 160 sets a value for each field of the added entry. The catalog storage module 160 obtains the identification information from the link ID 801 of the added entry. The catalog storage module 160 adds an entry to the history table 820, sets the obtained identification information in the link ID 821, and stores the SQL execution date and time in the registration date and time 822.

(Step S503-4) The catalog storage module 160 refers to the second link table 810 and determines whether or not there is an entry matching the retrieval condition.

(Step S503-5) In a case where there is an entry matching the retrieval condition, the catalog storage module 160 obtains identification information from the link ID 811 of the entry. The catalog storage module 160 adds an entry to the history table 820, sets the obtained identification information in the link ID 821, and stores the SQL execution date and time in the registration date and time 822. In a case where there are no entries matching the retrieval condition, the catalog storage module 160 registers an entry in the second link table 810, and sets the identification information in the link ID 811. Further, the catalog storage module 160 sets a value for each field of the added entry. The catalog storage module 160 obtains the identification information from the link ID 811 of the added entry. The catalog storage module 160 adds an entry to the history table 820, sets the obtained identification information in the link ID 821, and stores the SQL execution date and time in the registration date and time 822.

The update processing of the trend DB 171 has been described above.

The processing step of Step S504 is identical to that in the first embodiment. After the processing step of Step S504, the catalog management module 112 of the retrieval system 100 determines whether or not there is one recommended SQL (Step S511).

In a case where there is one recommended SQL, the catalog management module 112 of the retrieval system 100 transmits the recommended SQL to the client terminal 101 via the application 120 (Step S505). The application 120 of the retrieval system 100 then ends the processing.

In a case where there are a plurality of recommended SQLs, the catalog management module 112 of the retrieval system 100 ranks the plurality of SQLs (Step S512). The ranking method is described later.

The catalog management module 112 of the retrieval system 100 transmits the plurality of ranked recommended SQLs to the client terminal 101 via the application 120 (Step S513). Then, the application 120 of the retrieval system 100 ends the processing.

The ranking is now described. In the second embodiment, the ranking of each of the recommended SQLs is determined based on three indices, namely: (1) a similarity degree of the retrieval condition, (2) a trend of the retrieval condition, and (3) a reliability of the user who has executed the SQL.

### (1) Similarity Degree of Retrieval Condition

The similarity degree of the retrieval condition is calculated when a recommended SQL is selected. The catalog management module 112 estimates that the SQL of a retrieval condition similar to the retrieval condition used by the user has a similar retrieval purpose, and ranks the recommended SQLs so that the recommended SQLs having a higher similarity degree are displayed preferentially.

### (2) Trend of Retrieval Condition

The trend of the retrieval condition represents a usage trend of at least one of the combinations of data items obtained from a plurality of user DBs 150 or the join conditions between the user DBs 150. The retrieval system 100 ranks the recommended SQLs so that the recommended SQLs in which a retrieval condition including a combination of data items or a join condition used by many users is defined are displayed preferentially.

In Step S512, the catalog management module 112 calculates an index for evaluating the trend of the retrieval condition of each recommended SQL. For example, the catalog management module 112 refers to the history table 820, and aggregates, in units of months, each of the number of times of the combinations of data items of the retrieval conditions and the join condition defined in the recommended SQLs for two months. The catalog management module 112 calculates the number of uses or a rate of increase in the number of uses as an index. The catalog management module 112 ranks the recommended SQLs so that recommended SQLs which has a large number of uses or a positive and large rate of increase in the number of uses and in which a retrieval condition including a combination of data items or a join condition is defined are displayed preferentially.

There is now described ranking focusing on the trend of the combination of data items.

In the latest month, when the usage frequency of an SQL in which a retrieval condition including the combination of data items corresponding to the link ID 801 “I1” is defined is less than the usage frequency of an SQL in which a retrieval condition including the combination of data items corresponding to the link ID 801 “I2” is defined, in this case, it is presumed that many users has performed retrieval by determining that there is a relationship in the combination of data items corresponding to the link ID 801 “I2,” and hence the SQL including the combination of data items corresponding to the link ID 801 “I2” can be expected to be highly beneficial. Therefore, the catalog management module 112 ranks the recommended SQLs so that the SQL including the combination of data items corresponding to “I2” is displayed preferentially.

Ranking is performed in a similar manner when the rate of increase in the number of uses in the latest month is used as an index. In addition, ranking focusing on the trend of a retrieval condition is also performed in a similar manner.

### (3) Reliability of the User Who has Executed the SQL

In a case where a user using the retrieval system 100 publishes documents, it is presumed that the knowledge obtained from the retrieval system 100 is used. Further, in a case where a large number of documents published by the user using the retrieval system 100 have been cited in other documents or the like, it is presumed that the document is highly important. Therefore, the retrieval system 100 evaluates the user's reliability based on the number of published documents and the number of citations, for example, and ranks the recommended SQLs so that the recommended SQL used by a user having a high reliability is displayed preferentially.

In Step S512, the catalog management module 112 calculates an index for evaluating the reliability of each recommended SQL. For example, the following processing is executed.

(Processing 1) The catalog management module 112 selects one recommended SQL from among a plurality of recommended SQLs. The catalog management module 112 refers to the catalog DB 170, and identifies the user who has used the selected recommended SQL. The catalog management module 112 performs the same processing for all the recommended SQLs.

(Processing 2) The catalog management module 112 selects one user from among the identified users. The catalog management module 112 refers to the public available information DB 172, and calculates the number of documents published by the selected user and the number of citations of the documents published by the selected user. In a case where the number of documents and the number of citations are calculated, a unit of aggregation may be set. For example, a method which calculates the number of documents and the number of citations in units of months can be used.

(Processing 3) The catalog management module 112 determines whether or not the processing is complete for all the identified users. In a case where the processing is not complete for all the identified users, the process returns to Processing 2.

(Processing 4) In a case where the processing is complete for all the identified users, the catalog management module 112 calculates an index for evaluating the reliability of each user based on the number of published documents and the number of citations of each user. For example, a total value and an average value of the number of published documents and the number citations are calculated as indices. The catalog management module 112 may also calculate an index by using a mathematical expression in which the number of published documents and the number of citations are used as variables.

(Processing 5) The catalog management module 112 ranks the recommended SQLs so that a recommended SQL used by a user having a large index is displayed preferentially.

The catalog management module 112 may perform the ranking by using any one of (1) the similarity degree of the retrieval condition, (2) the trend of the retrieval condition, and (3) the reliability of the user who has executed the SQL, or may perform the ranking by combining two or more of those. In a case of ranking by combining two or more of those, the catalog management module 112 applies a weighting to the rank of each index to determine a final rank.

According to the second embodiment, the user can perform data retrieval with reference to recommended SQLs having high usefulness by ranking a plurality of recommended SQLs and displaying the ranked recommended SQLs.

### Third Embodiment

In a retrieval system 100 in a third embodiment of this invention, SQLs registered in the catalog DB 170 are analyzed, a new SQL is automatically generated based on the analysis results, and the new SQL is registered in the catalog DB 170. Description is now given of the third embodiment while mainly focusing on the differences from the second embodiment.

The configuration of the system of the third embodiment is identical to that in the second embodiment. The function configuration of the retrieval system 100 in the third embodiment is identical to that in the second embodiment. Further, the data structure of the information held by the retrieval system 100 in the third embodiment is identical to that in the second embodiment. The processing to be executed when the retrieval system 100 in the third embodiment receives a retrieval request is identical to the processing to be executed in the second embodiment.

In the third embodiment, the point that the catalog storage module 160 periodically executes catalog automatic generation processing is different from the second embodiment. Examples of the catalog automatic generation processing may include the following two processing methods.

(Processing Method 1) The catalog storage module 160 obtains the SQLs included in the catalog 400 stored in the catalog DB 170, and compares a plurality of the SQLs, for example, to thereby identify a retrieval condition (combination of data items and join condition) which has a high usage frequency.

The catalog storage module 160 generates a new retrieval condition based on a plurality of retrieval conditions which partially match. Specifically, the catalog storage module 160 generates a new combination of data items and a new join condition by using the combinations of data items and join conditions of a plurality of retrieval conditions which partially match. For example, a new combination of data items and a new join condition are generated by performing operations such as integration and replacement. It should be noted that the combinations of data items and the join conditions present in the catalog DB 170 are excluded.

The catalog storage module 160 generates an SQL by using a new combination of data items and a new join condition, and registers the catalog 400 including the SQL in the catalog DB 170. The retrieval system 100 is set for the user information on the catalog 400, and the generation date and time is set in the execution date and time.

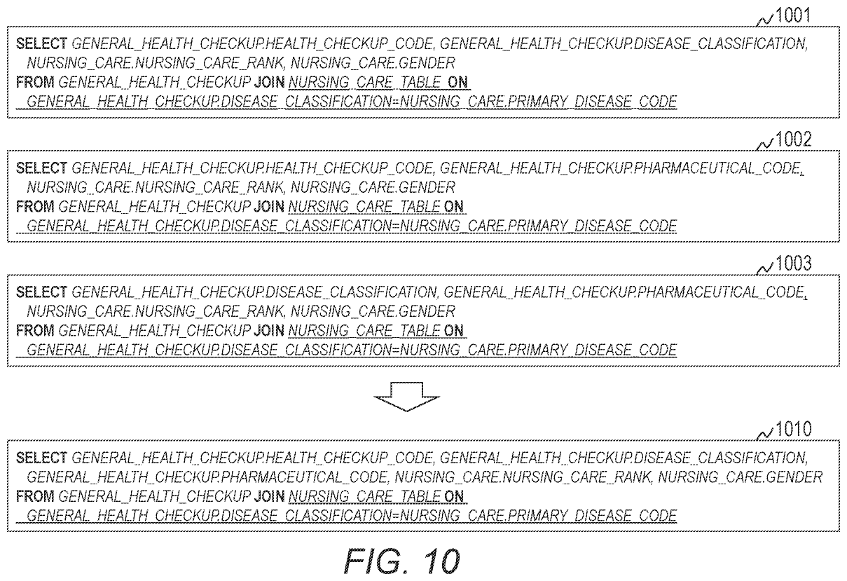

FIG. 10 is a diagram for illustrating an example of an SQL generated by the catalog automatic generation processing in the third embodiment.

There is now described a case in which the catalog 400 relating to an SQL 1001, an SQL 1002, and an SQL 1003 is registered in the catalog DB 170. In this case, the health checkup code 303, the disease classification 304, the pharmaceutical code 305, the nursing care rank 312, and the gender 314 are presumed to be related to one another. Therefore, the catalog storage module 160 generates an SQL 1010 including all of the data items.

(Processing Method 2) The catalog storage module 160 refers to the trend DB 171 and identifies the retrieval conditions (combination of data items and join condition) that have a high usage frequency.

The catalog storage module 160 generates a new combination of data items and a new join condition by using the combinations of data items and join conditions which partially match. For example, a new combination of data items and a new join condition are generated by performing operations such as integration and replacement. It should be noted that the combinations of data items and the join conditions present in the catalog DB 170 are excluded.

The catalog storage module 160 generates an SQL by using a new combination of data items and a new join condition, and registers the catalog 400 including the SQL in the catalog DB 170. The retrieval system 100 is set for the user information on the catalog 400, and the generation date and time is set in the execution date and time.

According to the third embodiment, an SQL that can achieve useful data retrieval can be presented by automatically generating and registering an SQL reflecting the combination of data items and the trend of the retrieval condition.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, which is coupled to a plurality of databases configured to store data having different data types,
the computer system comprising a computer including a processor, a storage device coupled to the processor, and a network interface coupled to the processor,
the computer system being configured to:
manage a catalog database configured to store a catalog including information on an SQL which has been used;
execute, in a case of receiving a retrieval request including a first SQL from a user terminal, the first SQL and output an execution result of the first SQL to the user terminal;
refer to the catalog database, and select at least one recommended SQL in which a retrieval condition, which is a retrieval condition for retrieving data by joining the plurality of databases, and is similar to the retrieval condition of the first SQL, is defined; and
present the at least one recommended SQL to the user terminal.

2. The computer system according to claim 1, wherein the computer system is configured to select the at least one recommended SQL based on a similarity degree calculated from a degree of matching between a combination of data items obtained from the plurality of databases in the first SQL and a combination of data items obtained from the plurality of databases in the SQL included in each of a plurality of the catalogs, and a degree of matching between a join condition between the plurality of databases in the first SQL and a join condition between the plurality of databases in the SQL included in each of the plurality of the catalogs.

3. The computer system according to claim 2, wherein the computer system is configured to:
determine, in a case where a plurality of the recommended SQLs have been selected, a ranking of each of the plurality of the recommended SQLs based on the similarity degree of each of the plurality of the recommended SQLs; and
present the ranked plurality of the recommended SQLs.

4. The computer system according to claim 2, wherein the computer system is configured to:
manage a history database for managing a usage trend of the retrieval condition;
determine, in a case where a plurality of the recommended SQLs have been selected, a ranking of each of the plurality of the recommended SQLs based on the usage trend of the retrieval condition of each of the plurality of the recommended SQLs by referring to the history database; and
present the ranked plurality of the recommended SQLs.

5. The computer system according to claim 2,
wherein the catalog includes information on a user who has executed the SQL, and
wherein the computer system is configured to:
manage a publicly available information database for managing information on documents relating to a user who uses the computer system;
determine, in a case where a plurality of the recommended SQLs have been selected, a ranking of each of the plurality of the recommended SQLs based on at least one of a number of documents relating to the user who has executed each of the plurality of the recommended SQLs or a number of citations of each of the documents by referring to the publicly available information database; and
present the ranked plurality of the recommended SQLs.

6. The computer system according to claim 2, wherein the computer system is configured to:
refer to the catalog database and identify the retrieval condition having a high usage frequency;
generate an SQL in which a retrieval condition generated by using a plurality of the identified retrieval conditions is defined; and
generate the catalog including information on the generated SQL and register the generated catalog in the catalog database.

7. A data retrieval support method to be executed by a computer system which is coupled to a plurality of databases configured to store data having different data types,
the computer system having a computer including a processor, a storage device coupled to the processor, and a network interface coupled to the processor,
the computer system being configured to manage a catalog database configured to store a catalog including information on an SQL which has been used,
the data retrieval support method including:
a first step of executing, by the computer, in a case of receiving a retrieval request including a first SQL from a user terminal, the first SQL and outputting an execution result of the first SQL to the user terminal;
a second step of referring, by the computer, to the catalog database, and selecting at least one recommended SQL in which a retrieval condition, which is a retrieval condition for retrieving data by joining the plurality of databases, and is similar to the retrieval condition of the first SQL, is defined; and
a third step of presenting, by the computer, the at least one recommended SQL to the user terminal.

8. The data retrieval support method according to claim 7, wherein the second step includes selecting, by the computer, the at least one recommended SQL based on a similarity degree calculated from a degree of matching between a combination of data items obtained from the plurality of databases in the first SQL and a combination of data items obtained from the plurality of databases in the SQL included in each of a plurality of the catalogs, and a degree of matching between a join condition between the plurality of databases in the first SQL and a join condition between the plurality of databases in the SQL included in each of the plurality of the catalogs.

9. The data retrieval support method according to claim 8,
wherein the second step includes determining, by the computer, in a case where a plurality of the recommended SQLs have been selected, a ranking of each of the plurality of the recommended SQLs based on the similarity degree of each of the plurality of the recommended SQLs, and
wherein the third step includes presenting, by the computer, the ranked plurality of the recommended SQLs.

10. The data retrieval support method according to claim 8,
wherein the computer system is configured to manage a history database for managing a usage trend of the retrieval condition,
wherein the second step includes determining, by the computer, in a case where a plurality of the recommended SQLs have been selected, a ranking of each of the plurality of the recommended SQLs based on the usage trend of the retrieval condition of each of the plurality of the recommended SQLs by referring to the history database, and
wherein the third step includes presenting, by the computer, the ranked plurality of the recommended SQLs.

11. The data retrieval support method according to claim 8,
wherein the catalog includes information on a user who has executed the SQL, and
wherein the computer system is configured to manage a publicly available information database for managing information on documents relating to a user who uses the computer system,
wherein the second step includes determining, by the computer, in a case where a plurality of the recommended SQLs have been selected, a ranking of each of the plurality of the recommended SQLs based on at least one of a number of documents relating to the user who has executed each of the plurality of the recommended SQLs or a number of citations of each of the documents by referring to the publicly available information database, and
wherein the third step includes presenting, by the computer, the ranked plurality of the recommended SQLs.

12. The data retrieval support method according to claim 8, further including:
referring, by the computer, to the catalog database and identifying the retrieval condition having a high usage frequency;
generating, by the computer, an SQL in which a retrieval condition generated by using a plurality of the identified retrieval conditions is defined; and
generating, by the computer, the catalog including information on the generated SQL and registering the generated catalog in the catalog database.
